(19) United States
(12) Patent Application Publication
(10) Pub. No.: US 2019/0107226 A1
(43) Pub. Date: Apr. 11, 2019

(54) DAMPENED VALVE ASSEMBLY

(71) Applicant: S.P.M. Flow Control, Inc., Fort Worth, TX (US)

(72) Inventors: Jacob Bayyouk, Richardson, TX (US); Aldo Iannetti, Glasgow (GB)

(21) Appl. No.: 16/158,122

(22) Filed: Oct. 11, 2018

Related U.S. Application Data
(60) Provisional application No. 62/571,022, filed on Oct. 11, 2017.

(51) Int. Cl. F16K 47/02; F04B 47/02; F04B 53/10; F16F 1/373; F16F 1/44

(52) U.S. Cl. CPC F16K 47/023; F04B 47/02; F04B 53/1027; F16F 1/3732; F05B 2280/5001; F04B 2201/0603; F05B 2260/964; F05B 2280/4003; F05B 2280/4004; F16F 1/44

(57) ABSTRACT

A valve assembly is provided for a reciprocating pump. The valve assembly includes a valve seat comprising a shoulder. The valve assembly also includes a valve body configured to move relative to the valve seat between an open position and a closed position. The valve body is separated from the shoulder of the valve seat in the open position. The valve body is sealingly engaged with the shoulder of the valve seat in the closed position. The valve assembly also includes a damper operatively connected between the valve body and the valve seat.

### CROSS-REFERENCE TO RELATED APPLICATION

This Application claims priority to and the benefit of U.S. Provisional Patent Application Ser. No. 62/571,022 filed on Oct. 11, 2017, which is incorporated herein by reference in its entirety.

### TECHNICAL FIELD

This disclosure relates to reciprocating pumps, and, in particular, to valve assemblies used in reciprocating pumps.

### BACKGROUND OF THE DISCLOSURE

In oilfield operations, reciprocating pumps are used for different applications such as fracturing subterranean formations to drill for oil or natural gas, cementing the wellbore, or treating the wellbore and/or formation. A reciprocating pump designed for fracturing operations is sometimes referred to as a “frac pump.” A reciprocating pump typically includes a power end and a fluid end (sometimes referred to as a cylindrical section). The fluid end can be formed of a one piece construction or a series of blocks secured together by rods. The fluid end includes a fluid cylinder having a plunger passage for receiving a plunger or plunger throw, an inlet fluid passage, and an outlet fluid passage (sometimes referred to as a discharge passage).

During operation of a reciprocating pump, a fluid is pumped into the fluid cylinder through the inlet passage and out of the pump through the outlet passage. The inlet and outlet passages each include a valve assembly to control the flow of fluid into and out of the fluid cylinder. For example, the valve assemblies can be differential pressure valves that are opened by differential pressure of fluid and allow the fluid to flow in only one direction through the corresponding inlet or outlet passage. The valve assemblies typically include a valve seat and a valve body that moves relative to the valve seat between an open position and a closed position. In the open position, the valve body is separated from the valve seat such that fluid can flow through the valve assembly. In the closed position, the valve body is sealingly engaged with the valve seat such that fluid is prevented from flowing through the valve assembly. But, repetitive engagement between the valve body and valve seat can wear out the valve assemblies. For example, reciprocating pumps often operate at pressures of 10,000 pounds per square inch (psi) and upward to 25,000 psi and at rates of up to 1,000 strokes per minute or even higher during fracturing operations. Accordingly, the relatively high cyclical rates and/or loads experienced by the valve assemblies can wear out the valve assemblies over time.

### SUMMARY

This summary is provided to introduce a selection of concepts in a simplified form that are further described below in the Detailed Description. This summary is not intended to identify key features or essential features of the claimed subject matter. Nor is it intended to be used as an aid in determining the scope of the claimed subject matter.

In a first aspect, a valve assembly is provided for a reciprocating pump. The valve assembly includes a valve seat comprising a shoulder. The valve assembly also includes a valve body configured to move relative to the valve seat between an open position and a closed position. The valve body is separated from the shoulder of the valve seat in the open position. The valve body is sealingly engaged with the shoulder of the valve seat in the closed position. The valve assembly also includes a damper operatively connected between the valve body and the valve seat.

In some embodiments, the damper is engaged in physical contact with a base of the valve body.

In one embodiment, the valve seat includes a valve guide and the valve body comprises a valve stem received within the valve guide. The damper extends at least partially around the valve stem of the valve body.

In some embodiments, the valve body includes a base and the valve seat comprises a central platform. The damper is operatively connected between the base of the valve body and the central platform of the valve seat.

In some embodiments, the valve seat includes a valve guide and the valve body includes a base and a valve stem extending from the base. The valve stem is received within the valve guide. The damper is engaged with the base of the valve body in the closed position of the valve body. The damper is engaged with the valve guide of the valve seat in the closed position of the valve body.

In one embodiment, the valve body includes a groove and the damper extends within the groove.

In one embodiment, the valve seat includes a groove and the damper extends within the groove.

In some embodiments, the valve body includes a groove and the damper extends within the groove. The damper is held within the groove by a retaining member.

In one embodiment, the damper is fixedly secured to at least one of the valve body or the valve seat.

In some embodiments, the valve assembly includes a valve stop having a valve guide. The valve body includes a valve stem received within the valve guide of the valve stop.

In one embodiment, the damper includes an elastomeric material.

In some embodiments, the damper includes at least one of a donut shape, a ring shape, or a circular shape.

In a second aspect, a reciprocating pump assembly includes a fluid passage and a valve assembly held within the fluid passage. The valve assembly includes a valve seat having a shoulder. The valve assembly includes a valve body configured to move relative to the valve seat between an open position and a closed position. The valve body is separated from the shoulder of the valve seat in the open position. The valve body is sealingly engaged with the shoulder of the valve seat in the closed position. The valve assembly includes a damper operatively connected between the valve body and the valve seat.

In some embodiments, the valve seat includes a valve guide and the valve body comprises a valve stem received within the valve guide. The damper extends at least partially around the valve stem of the valve body.

In one embodiment, the valve seat includes a valve guide and the valve body includes a base and a valve stem extending from the base. The valve stem is received within the valve guide. The damper is engaged with the base of the valve body in the closed position of the valve body. The damper is engaged with the valve guide of the valve seat in the closed position of the valve body.

In one embodiment, at least one of the valve body or the valve seat includes a groove. The damper extends within the groove.

In some embodiments, at least one of the valve seat or the valve body includes a groove. The damper is held within the groove by a retaining member.

In some embodiments, the valve assembly includes a valve stop having a valve guide. The valve body includes a valve stem received within the valve guide of the valve stop.

In one embodiment, the damper includes an elastomeric material.

In a third aspect, a valve assembly for a reciprocating pump includes a valve seat having a shoulder and a valve guide. The valve assembly includes a valve body configured to move relative to the valve seat between an open position and a closed position. The valve body is separated from the shoulder of the valve seat in the open position. The valve body is sealingly engaged with the shoulder of the valve seat in the closed position. The valve body includes a base and a valve stem extending from the base. The valve stem is received within the valve guide of the valve seat. The valve assembly includes a damper operatively connected between the valve body and the valve seat. The damper is engaged in physical contact with the base of the valve body.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is an elevational view of a reciprocating pump assembly according to an exemplary embodiment.

FIG. 2 is a cross-sectional view of a fluid end portion of the reciprocating pump assembly shown in FIG. 1 according an exemplary embodiment.

FIG. 3 is a cross-sectional view of a portion of the fluid end portion shown in FIG. 2 illustrating a portion of an inlet valve assembly according to an exemplary embodiment.

FIG. 4 is a perspective view of a damper of the inlet valve assembly shown in FIG. 3 according to an exemplary embodiment.

FIG. 5 is a cross-sectional view illustrating an inlet valve assembly according to another exemplary embodiment.

FIG. 6 is a cross-sectional view illustrating an inlet valve assembly according to another exemplary embodiment.

FIG. 7 is a cross-sectional view illustrating an inlet valve assembly according to another exemplary embodiment.

FIG. 8 is a cross-sectional view illustrating an inlet valve assembly according to another exemplary embodiment.

FIG. 9 is a cross-sectional view illustrating an inlet valve assembly according to another exemplary embodiment.

FIG. 10 is a cross-sectional view illustrating an inlet valve assembly according to another exemplary embodiment.

Corresponding reference characters indicate corresponding parts throughout the drawings.

### DETAILED DESCRIPTION

Certain embodiments of the disclosure provide a valve assembly for a reciprocating pump. The valve assembly includes a valve seat having a shoulder, and a valve body configured to move relative to the valve seat between an open position and a closed position. The valve body is separated from the shoulder of the valve seat in the open position. The valve body is sealingly engaged with the shoulder of the valve seat in the closed position. The valve assembly also includes a damper operatively connected between the valve body and the valve seat.

Certain embodiments of the disclosure provide a damper that dampens (e.g., cushions, reduces impact velocity, etc.) the engagement (i.e., the impact) of the valve body with the valve seat. Certain embodiments of the disclosure reduce the wear on the valve body and the valve seat from the repetitive opening and closing of the inlet valve assembly during operation of the reciprocating pump. Certain embodiments of the disclosure extend the life of the inlet valve assembly and thereby extend the life of a fluid end portion of the reciprocating pump.

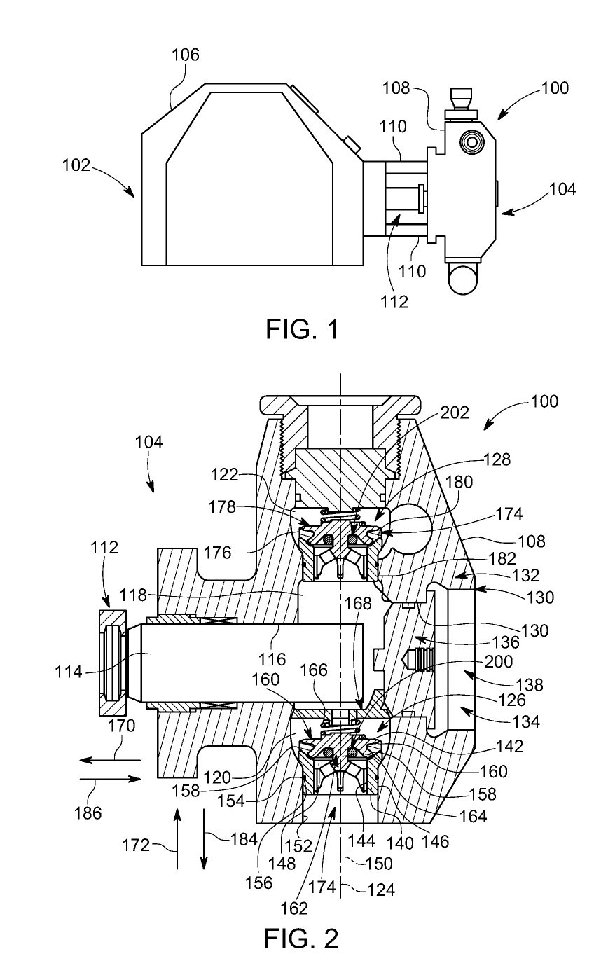

Referring to FIG. 1, an illustrative embodiment of a reciprocating pump assembly 100 is presented. The reciprocating pump assembly 100 includes a power end portion 102 and a fluid end portion 104 operably coupled thereto. The power end portion 102 includes a housing 106 in which a crankshaft (not shown) is disposed. Rotation of the crankshaft is driven by an engine or motor (not shown) of the power end portion 102. The fluid end portion 104 includes a fluid cylinder 108 (sometimes referred to as a “fluid end block”), which in the exemplary embodiments is connected to the housing 106 via a plurality of stay rods 110. Other structures may be used to connect the fluid end portion 104 to the housing 106 in addition or alternatively to the stay rods 110. In operation, the crankshaft reciprocates a plunger rod assembly 112 between the power end portion 102 and the fluid end portion 104 to thereby pump (i.e., move) fluid through the fluid cylinder 108.

According to some embodiments, the reciprocating pump assembly 100 is freestanding on the ground, mounted to a trailer for towing between operational sites, mounted to a skid, loaded on a manifold, otherwise transported, and/or the like. The reciprocating pump assembly 100 is not limited to frac pumps or the plunger rod pump shown herein. Rather, the embodiments disclosed herein may be used with any other type of pump that includes a valve assembly.

Referring now to FIG. 2, the plunger rod assembly 112 includes a plunger 114 extending through a plunger passage 116 and into a pressure chamber 118 formed in the fluid cylinder 108. At least the plunger passage 116, the pressure chamber 118, and the plunger 114 together may be characterized as a “plunger throw.” According to some embodiments, the reciprocating pump assembly 100 includes three plunger throws (i.e., a triplex pump assembly); however, in other embodiments, the reciprocating pump assembly 100 includes a greater or fewer number of plunger throws.

As shown in FIG. 2, the fluid cylinder 108 includes inlet and outlet fluid passages 120 and 122, respectively, formed therein. Optionally, the inlet and outlet fluid passages 120 and 122, respectively, are coaxially disposed along a fluid passage axis 124, for example as is shown in FIG. 2. As described in greater detail below, fluid is adapted to flow through the inlet and outlet fluid passages 120 and 122, respectively, and along the fluid passage axis 124. An inlet valve assembly 126 is disposed in the inlet fluid passage 120 and an outlet valve assembly 128 is disposed in the outlet fluid passage 122. In the exemplary embodiments, the valve assemblies 126 and 128 are spring-loaded, which, as described in greater detail below, are actuated by at least a predetermined differential pressure across each of the valve assemblies 126 and 128.

The fluid cylinder 108 of the fluid end portion 104 of the reciprocating pump assembly 100 includes an access port 130. The access port 130 is defined by an opening that extends through a body 132 of the fluid cylinder 108 to provide access to the pressure chamber 118 and thereby internal components of the fluid cylinder 108 (e.g., the inlet valve assembly 126, the outlet valve assembly 128, the plunger 114, etc.) for service (e.g., maintenance, replacement, etc.) thereof. The access port 130 of the fluid cylinder 108 is closed using a suction cover assembly 134 to seal the pressure chamber 118 of the fluid cylinder 108 at the access port 130. The suction cover assembly 134 includes a suction cover 136 and a suction cover nut 138 that holds the suction cover 134 within the access port 130.

The inlet valve assembly 126 includes a valve seat 140 and a valve body 142 that is configured to be sealingly engaged therewith. The valve seat 140 includes a body having an inner surface 144 and an outer surface 146. The inner surface 144 forms an inlet valve bore 148 that extends along a valve seat axis 150, which is coaxial with the fluid passage axis 124 when the inlet valve assembly 126 is disposed in the inlet fluid passage 120. The outer surface 146 of valve seat 140 engages in physical contact with a wall 152 of the inlet fluid passage 120. A sealing element 154 (e.g., an o-ring, etc.) may be disposed in a groove 156 formed in the outer surface 146 of valve seat 140 to sealingly engage the wall 152 of the inlet fluid passage 120. According to some examples, the outer surface 146 of the valve seat 140 forms an interference fit (i.e., press-fit) with the wall 152 of the inlet fluid passage 120 to hold the valve seat 140 within the inlet fluid passage 120. The valve seat 140 includes a shoulder 158, which in the exemplary embodiments is tapered (i.e., extends at an oblique angle relative to the valve seat axis 150). In other examples, the shoulder 158 of the valve seat 140 extends approximately perpendicular to the valve seat axis 150.

The valve body 142 includes a valve head 160 having a base 162. In the example shown in FIG. 2, a valve stem 164 extends from the base 162 of the valve head 160. In a closed position of the valve body 142, the valve head 160 sealingly engages at least a portion of the shoulder 158 of the valve seat 140 to prevent fluid flow through the inlet valve assembly 126. In the exemplary embodiments, the valve body 142 is engaged and otherwise biased by a spring 166, which, as discussed in greater detail below, biases the valve body 142 to the closed position. The inlet valve assembly 126 includes a valve stop 168, which limits the travel of the valve body 142 in an open position of the valve body 142.

According to certain embodiments, at least a portion of the valve seat 140 and/or at least a portion of the valve body 142 is formed from stainless steel. But, the valve seat 140 and/or the valve body 142 may be formed from any other material in addition or alternative to stainless steel.

In the exemplary embodiments illustrated herein, the outlet valve assembly 128 is substantially similar to the inlet valve assembly 126 and therefore will not be described in further detail.

In operation, the plunger 114 reciprocates within the plunger passage 116 for movement into and out of the pressure chamber 118. That is, the plunger 114 moves back and forth horizontally, as viewed in FIG. 2, away from and towards the fluid passage axis 124 in response to rotation of the crankshaft (not shown) that is enclosed within the housing 106 (FIG. 1) of the power end portion 102 (FIG. 1). Movement of the plunger 114 in the direction of arrow 170 away from the fluid passage axis 124 and out of the pressure chamber 118 will be referred to herein as the suction stroke of the plunger 114. As the plunger 114 moves along the suction stroke, the inlet valve assembly 126 is opened to the open position of the valve body 142. More particularly, as the plunger 114 moves away from the fluid passage axis 124 in the direction of arrow 170, the pressure inside the pressure chamber 118 decreases, creating a differential pressure across the inlet valve assembly 126 and causing the valve body 142 to move (relative to the valve seat 140) upward, as viewed in FIG. 2, along the valve seat axis 150 in the direction of arrow 172. As a result of the upward movement of the valve body 142 along the valve seat axis 150, the spring 166 is compressed and the valve head 160 of the valve body 142 separates from the tapered shoulder 158 of the valve seat 140 to move the valve body 142 to the open position. In the open position of the valve body 142, fluid entering through an inlet 174 of the inlet fluid passage 120 flows along the fluid passage axis 124 and through the inlet valve assembly 126, being drawn into the pressure chamber 118. To flow through the inlet valve assembly 126, the fluid flows through the inlet valve bore 148 and along the valve seat axis 150.

As can be seen in FIG. 2, the valve stop 168 is engaged with the spring 166 to limit the travel of the valve body 142 in the open position. More particularly, the valve stop 168 prevents the valve body 142 from moving past the fully open position of the valve body 142.

During the fluid flow through the inlet valve assembly 126 and into the pressure chamber 118, the outlet valve assembly 128 is in a closed position wherein a valve head 176 of a valve body 178 of the outlet valve assembly 128 is engaged with a shoulder 180 of a valve seat 182 of the outlet valve assembly 128. Fluid continues to be drawn into the pressure chamber 118 until the plunger 114 is at the end of the suction stroke of the plunger 114, wherein the plunger 114 is at the farthest point from the fluid passage axis 124 of the range of motion of the plunger 114.

At the end of the suction stroke of the plunger 114, the differential pressure across the inlet valve assembly 126 is such that the spring 166 of the inlet valve assembly 126 begins to decompress and extend, forcing the valve head 160 of the valve body 142 of the inlet valve assembly 126 to move (relative to the valve seat 140) downward, as viewed in FIG. 2, along the valve seat axis 150 in the direction of arrow 184. As a result, the inlet valve assembly 126 moves to the closed position of the valve body 142 wherein the valve head 160 of the valve body 142 is sealingly engaged with the shoulder 158 of the valve seat 140.

Movement of the plunger 114 in the direction of arrow 186 toward the fluid passage axis 124 and into the pressure chamber 118 will be referred to herein as the discharge stroke of the plunger 114. As the plunger 114 moves along the discharge stroke into the pressure chamber 118, the pressure within the pressure chamber 118 increases. The pressure within the pressure chamber 118 increases until the differential pressure across the outlet valve assembly 128 exceeds a predetermined set point, at which point the outlet valve assembly 128 opens and permits fluid to flow out of the pressure chamber 118 along the fluid passage axis 124, being discharged through the outlet valve assembly 128. During the discharge stroke of the plunger 114, the valve body 142 of the inlet valve assembly 126 is positioned in the closed position wherein the valve head 160 of the valve body 142 is sealingly engaged with the shoulder 158 of the valve seat 140.

Although shown herein as being a helical (i.e., coil) compression spring, additionally or alternatively the spring 166 can include any type of spring, such as, but not limited to, a flat spring, a machined spring, a serpentine spring, a torsion spring, a tension spring, a constant spring, a variable spring, a variable stiffness spring, a leaf spring, a cantilever spring, a volute spring, a v-spring, and/or the like.

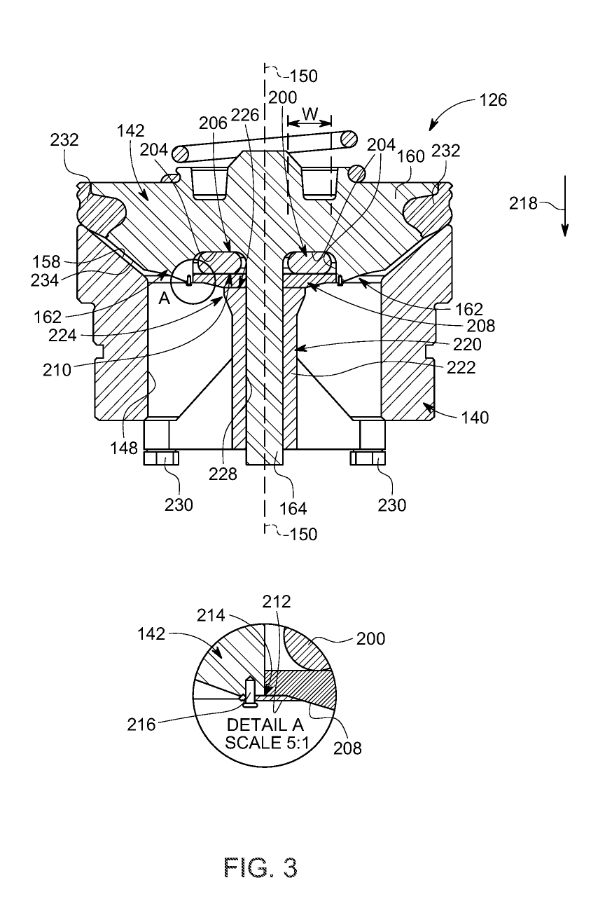

As shown in FIG. 2, the inlet valve assembly 126 includes a damper 200 operatively connected between the valve body 142 and the valve seat 140 thereof. Similarly, the outlet valve assembly 128 includes a damper 202 operatively connected between the valve body 178 and the valve seat 182 thereof. As will be described below with respect to the damper 200, the dampers 200 and 202 damper (e.g., cushion, reduce impact velocity, etc.) the repetitive engagement between the valve bodies 142 and 178 and the respective valve seats 140 and 182 during cyclical opening and closing of the inlet and outlet valve assemblies 126 and 128, for example to reduce wear of the valve assemblies 126 and 128. Various embodiments of the damper 200 of the inlet valve assembly 126 are described below with reference to FIGS. 3-7. It should be understood that the damper 202 of the outlet valve assembly 128 is substantially similar to, and can be similarly configured as, the damper 200 of the inlet valve assembly 126. The damper 202 of the outlet valve assembly 128 therefore will not be described in more detail herein.

Any of the valve assemblies shown in FIGS. 3 and 5-10, which are described in more detail below, may be used as either the inlet valve assembly 126 or outlet valve assembly 128. For instance, the valve assembly shown in FIG. 3 that includes a damper 200 and a valve stem 164 may be positioned in the fluid end portion as either the input valve assembly 126 or the outlet valve assembly 128. For the sake of clarity, the embodiments in FIGS. 3 and 5-10 are described below as being inlet valve assemblies 126, 326, 426, 626, 726, 826, and 926. Yet, any of the valve assemblies may be used as the outlet valve assembly 128 as well.

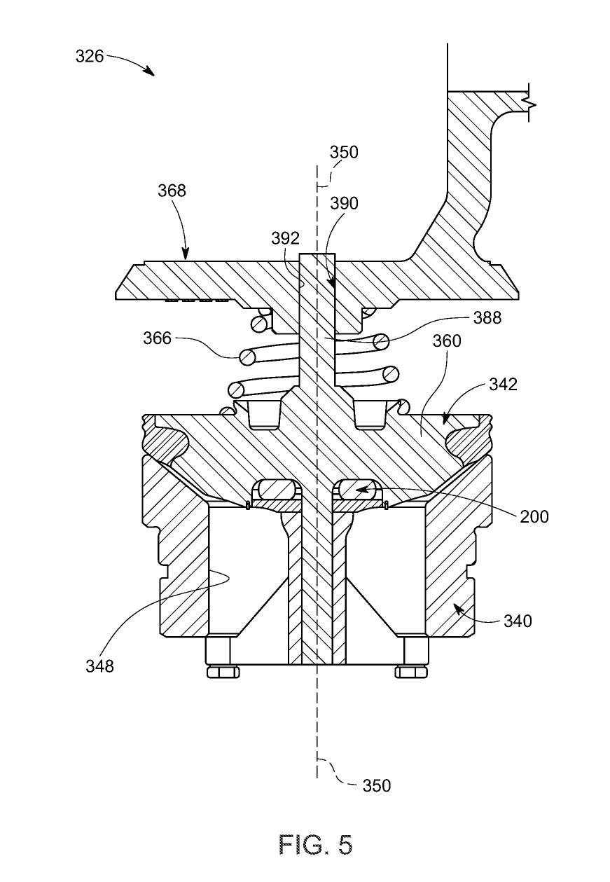

Moreover, any combination of the disclosed valve assemblies in FIGS. 2-3 and 5-10 may be used as the inlet valve assembly 126 and outlet valve assembly 128. For example, the inlet valve assembly 126 in FIG. 2 may be positioned in the fluid end portion 104 on the inlet side and the valve assembly in FIG. 3 may be used as the outlet valve assembly 128. Alternatively, the valve assemblies in FIGS. 5-10 may be used as the inlet valves assembly and outlet valve assembly, respectively. Thus, the various valve assemblies in this disclosure and the accompanying drawings, as well as any combination thereof, may be used as the inlet valve assembly 126 and outlet valve assembly 128.

Referring now to FIG. 3, another embodiment of a configuration of the damper 200 and a configuration of the inlet valve assembly 126 is shown. The damper 200 is shown in FIG. 3 as operatively connected between the valve body 142 and the valve seat 140. More particularly, in the example of FIG. 3, the valve head 160 of the valve body 142 includes a groove 204 that extends into the base 162 of the valve head 160. The damper 200 extends within the groove 204 such that a side 206 of the damper 200 is engaged in physical contact with the base 162 of the valve head 160 when the valve body 142 is in the closed position. In the example of FIG. 3, the valve body 142 includes the valve stem 164 extending from the base 162 of the valve head 160. As shown in FIG. 3, the damper 200 extends at least partially around the valve stem 164.

In the exemplary embodiment of FIGS. 2 and 3, the damper 200 is held within the groove 204 by a retaining member 208 that extends over a side 210 of the damper 200 that is opposite the side 206. In addition or alternatively, the damper 200 can be fixedly secured to the valve body 142 within the groove 204 (e.g., an interference fit, a snap fit, adhesive, bonding, welding, bolts, screws, buckles, clips, latches, pins, nails, etc.) to hold the damper 200 within the groove 204. As will be described below, the retaining member 208 can facilitate providing that the damper 200 deforms in a predetermined manner during compression of the damper 200, for example a substantially even deformation across a width W of the damper 200, etc.

Referring now to detail A of FIG. 3, the retaining member 208 can be held in position over the side 210 of the damper 200 at least in part by a retaining flange 212 that extends over the retaining member 208 and an edge 214 of the groove 204. In the exemplary embodiment of FIGS. 2 and 3, the retaining flange 212 is secured to the base 162 of the valve head 160 using a bolt 216. But, additionally or alternatively any other method, structure, and/or the like can be used to secure the retaining flange 212 to the valve head 160 (e.g., an interference fit, a snap fit, an adhesive, bonding, welding, screws, buckles, clips, latches, pins, nails, etc.). As will be described below, the retaining flange 212 can function as a stop that facilitates holding the retaining member 208 (and/or the damper 200) in the position during movement of the valve body 142 to the open position. The retaining member 208 and the retaining flange 212 each can be fabricated from any material(s) that enable the retaining member 208 and the retaining flange 212 to function as described and/or illustrated herein, such as, but not limited to, a metal, a composite material, and/or the like.

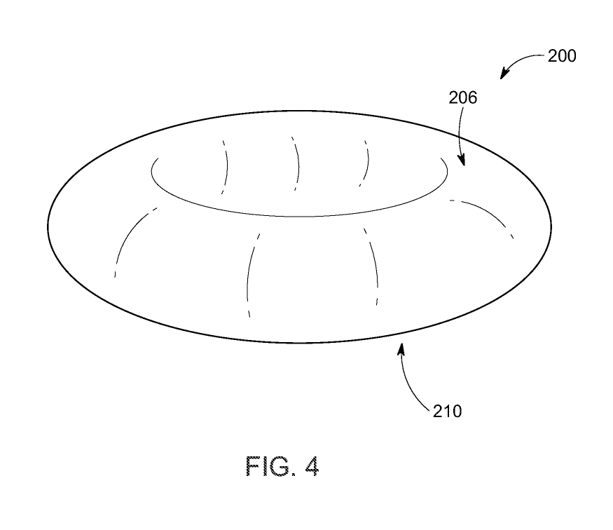

Referring now to FIG. 4, in the exemplary embodiments illustrated herein, the damper 200 is a continuous ring having a circular shape. As can be seen in FIG. 4, the sides 206 and 210 of the damper 200 are rounded such that the damper 200 has the shape of a donut in the illustrated embodiment. But, the damper 200 additionally or alternatively can include any other shape that enables the damper 200 to function as described and/or illustrated herein. For example, the damper 200 can have another shape instead of being circular, such as, but not limited to, a triangular shape, a square shape, a rectangular shape, an oval shape, an ellipsoidal shape, a hexagonal shape, an octagonal shape, and/or the like. Moreover, and for example, the sides 206 and/or 210 of the damper 200 can be approximately planar such that the damper 200 has the shape of a disk or puck instead of the donut shape shown herein. Although shown as being a continuous (i.e., closed) ring, in other embodiments the damper 200 is not continuous such that the damper 200 defines an open ring. Moreover, the damper 200 can include more than one segment (e.g., two segments, three segments, etc.) in other embodiments.

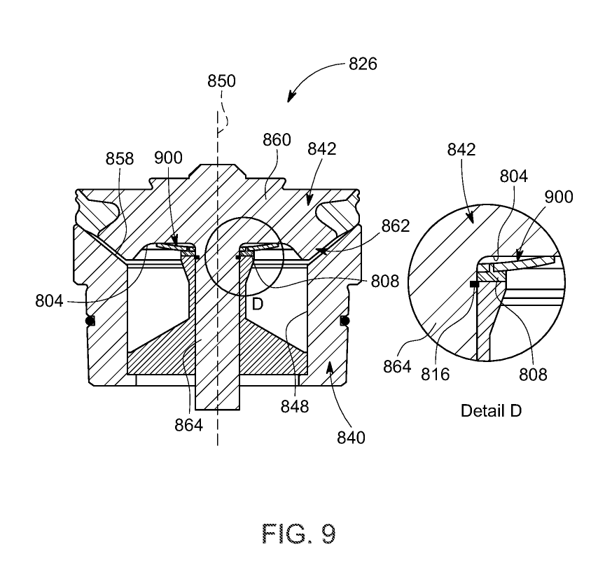

The damper 200 is elastically compressible and can be fabricated from any material(s), size, shape, and/or the like that provides the damper 200 with any damping ability (i.e., spring force, resilience, cushioning, reducing impact velocity, etc.) that enables the damper 200 to function as described and/or illustrated herein. In the exemplary embodiments of FIGS. 2-8, the damper 200 is fabricated from one or more elastomeric materials, such as, but not limited to, urethane, unsaturated rubber, saturated rubber, polysulfide rubber, resilin, elastin, polyisoprene, polybutadiene, chloroprene, butyl rubber, thermoplastics, elastolefin, and/or the like. In other embodiments, the damper 200 can have other configurations (e.g., other material(s), sizes, shapes, etc.) that enable the damper 200 to function as described and/or illustrated herein (e.g., the damper 900 shown in FIG. 9, etc.).

Referring again to FIG. 3, the valve seat 140 includes a valve guide 220 in the example shown in FIGS. 2 and 3. More particularly, the valve guide 220 is defined by a central column 222 that extends within the inlet valve bore 148 along the valve seat axis 150. The central column 222 of the valve guide 220 includes an end portion 224 that defines a central platform 226 of the valve seat 140. The central column 222 of the valve guide 220 includes a guide opening 228 that receives the valve stem 164 of the valve body 142 therein. The valve guide 220 is thereby configured to guide movement of the valve body 142 along the valve seat axis 150 between the open and closed positions of the valve body 142, for example to prevent the valve body 142 from tilting relative to the valve seat axis 150 as the valve body 142 moves between the open and closed positions.

In the exemplary embodiments, the valve stem 164 is integrally formed with a unitary construction with the base 162 of the valve body 142 and the valve guide 220 is a separate component (from the remainder of the valve seat 140) that is secured to the valve seat 140 using bolts 230. But, in other embodiments the valve stem 164 can be a separate component (from the remainder of the valve body 142) that is secured to the base 162 of the valve body 142 using any suitable fastener and/or fit, such as, but not limited to, an interference fit, a snap fit, an adhesive, bonding, welding, bolts, screws, buckles, clips, latches, pins, nails, and/or the like. Moreover, in other embodiments the valve guide 220 can be integrally formed with a unitary construction with the valve seat 140 or can be secured to the valve seat 140 using any other type of fastener and/or fit (e.g., an interference fit, a snap fit, an adhesive, bonding, welding, screws, buckles, clips, latches, pins, nails, etc.)

As can be seen in FIG. 3, the damper 200 is operatively connected between the base 162 of the valve head 160 of the valve body 142 and the central platform 226 of the valve seat 140. More particularly, the operation of the damper 200 in the exemplary embodiment of FIGS. 2 and 3 will now be described with reference to FIG. 3. In the open position of the valve body 142, the retaining member 208 is separated from the central platform 226 of the valve guide 220. As the valve head 160 of the valve body 142 moves from the open position toward the closed position, the retaining member 208 engages in physical contact with the central platform 226 defined by the valve guide 220 of the valve seat 140. As the valve body 142 continues to move toward the closed position, the engagement between the retaining member 208 and the central platform 226 compresses the damper 200 axially along the valve seat axis 150 until the valve head 160 of the valve body 142 reaches the fully closed position, wherein the damper 200 is fully compressed and a surface 234 of the valve head 160 of the valve body 142 is engaged in physical contact with the shoulder 158 of the valve seat 140 to thereby provide the fluid seal between the valve body 142 and the valve seat 140 (e.g., metal to metal engagement between the valve head 160 and the shoulder 158, etc.). The axial compression of the damper 200 along the valve seat axis 150 dampens (e.g., cushions, reduces impact velocity, etc.) the engagement (i.e., the impact) of the valve head 160 of the valve body 142 with the shoulder 158 of the valve seat 140. The cushioning provided by the damper 200 can reduce the wear on the valve body 142 and the valve seat 140 (e.g., the shoulder 158, etc.) over the repeated opening and closing of the inlet valve assembly 126 during operation of the reciprocating pump 100 (FIGS. 1 and 2), which can extend the life of the inlet valve assembly 126 and thereby extend the life of the fluid end portion 104 (FIGS. 1 and 2).

In some examples, the retaining member 208 enables the damper 200 to deform in a predetermined manner (e.g., a substantially even deformation across the width W of the damper 200, etc.) during compression of the damper 200 along the valve seat axis 150. During movement of the valve head 160 along the valve seat axis 150 to the open position of the valve body 142, the retaining flange 212 functions in some examples as a stop that holds the retaining member 208 (and/or the damper 200) in the position shown herein. For example, the retaining flange 212 can prevent the retaining member 208 (and/or the damper 200) from moving relative to the valve head 160 in the direction of the arrow 218 (e.g., sliding down the valve stem 164, etc.) into the path of the fluid flowing through the inlet valve bore 148. The retaining flange 212 can thereby prevent the retaining member 208 and/or the damper 200 from obstructing the flow of fluid through the inlet valve assembly 126.

Optionally, the valve head 160 of the valve body 142 holds a seal 232 (e.g., urethane, another elastomeric material, etc.) that sealingly engages the shoulder 158 of the valve seat 140 in the closed position of the valve body 142. In some examples, the seal 232 provides additional dampening of the engagement between the valve body 142 and the valve seat 140. In some examples, additional dampening and/or sealing material (e.g., urethane, another elastomeric material, etc.) is positioned along the shoulder 158, along the surface 234, within the groove 204, at another location along the valve body 142 and/or the valve seat 140, and/or the like.

In some other embodiments, the valve body 142 does not include the valve stem 164 and the central column 222 does not include the guide opening 228 such that the central column 222 does not provide a guide feature. In such embodiments, the retaining member 208 engages in physical contact with the central platform 226 of the central column 222 as the valve head 160 of the valve body 142 moves from the open position toward the closed position.

In addition or alternatively to the valve stem 164 and the valve guide 220, the inlet valve assembly 126 can include a valve stem that is received within a valve guide of the valve stop 168 to guide movement of the valve body 142 along the valve seat axis 150 between the open and closed positions. For example, and referring now to FIG. 5, an inlet valve assembly 326 includes a valve seat 340 and a valve body 342 that is configured to be sealingly engaged therewith in a closed position of the valve body 342. The valve seat 340 includes an inlet valve bore 348 that extends along a valve seat axis 350.

The valve body 342 includes a valve head 360 and a valve stem 388 extending therefrom. In the example of FIG. 5, the valve body 342 is engaged and otherwise biased by a spring 366 that biases the valve body 342 to the closed position. The inlet valve assembly 326 includes a valve stop 368, which limits the travel of the valve body 342 in an open position of the valve body 342. The inlet valve assembly 326 includes the damper 200 operatively connected between the valve body 342 and the valve seat 340 for dampening (e.g., cushioning, reducing impact velocity, etc.) the repetitive engagement between the valve body 342 and the valve seat 340 during cyclical opening and closing of the inlet valve assembly 326.

The valve stop 368 includes a valve guide 390 defined by a guide opening 392 that extends at least partially through the valve stop 368. The guide opening 392 receives the valve stem 388 of the valve body 142 therein to guide movement of the valve body 342 along the valve seat axis 350 between the open and closed positions of the valve body 342, for example to prevent the valve body 342 from tilting relative to the valve seat axis 350 as the valve body 342 moves between the open and closed positions.

In the example of FIG. 5, the valve stem 388 is integrally formed with a unitary construction with the valve body 342. But, in other embodiments the valve stem 388 can be a separate component (from the remainder of the valve body 342) that is secured to the valve body 342 using any suitable fastener and/or fit, such as, but not limited to, an interference fit, a snap fit, an adhesive, bonding, welding, bolts, screws, buckles, clips, latches, pins, nails, and/or the like.

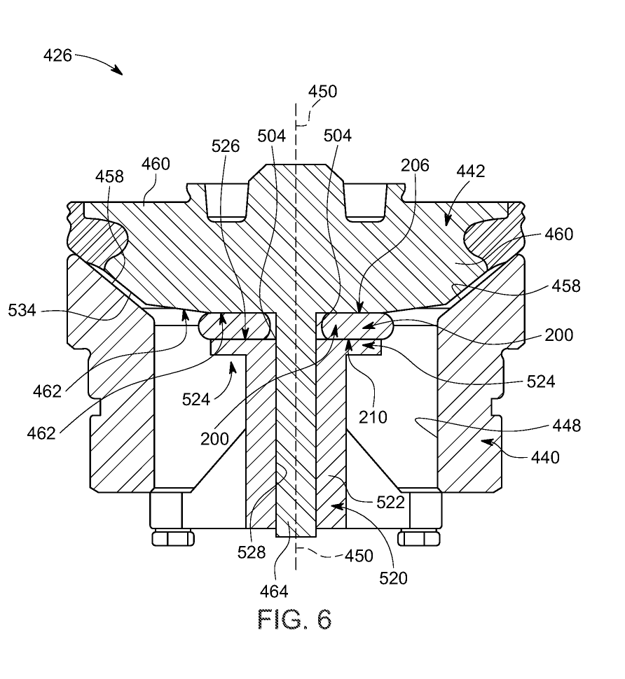

Referring now to FIG. 6, another configuration of the damper 200 within an inlet valve assembly 426 is shown. The inlet valve assembly 426 includes a valve seat 440 and a valve body 442 that is configured to be sealingly engaged therewith in a closed position of the valve body 442. The valve seat 440 includes a shoulder 458 and an inlet valve bore 448 that extends along a valve seat axis 450. The valve body 442 includes a valve head 460 having a base 462. In the example shown in FIG. 6, a valve stem 464 extends from the base 462 of the valve head 460. In the closed position of the valve body 442, the valve head 460 sealingly engages at least a portion of the shoulder 458 of the valve seat 440 to prevent fluid flow through the inlet valve assembly 426.

The valve seat 440 includes a valve guide 520 in the example shown in FIG. 6. More particularly, the valve guide 520 is defined by a central column 522 that extends within the inlet valve bore 448 along the valve seat axis 550. The central column 522 of the valve guide 520 includes an end portion 524 that defines a central platform 526 of the valve seat 440. The central column 522 of the valve guide 520 includes a guide opening 528 that receives the valve stem 464 of the valve body 442 therein. The valve guide 520 is thereby configured to guide movement of the valve body 442 along the valve seat axis 450 between the open and closed positions of the valve body 442, for example to prevent the valve body 442 from tilting relative to the valve seat axis 450 as the valve body 442 moves between the open and closed positions.

One embodiment of a configuration of the damper 200 is shown operatively connected between the valve body 442 and the valve seat 440 for dampening (e.g., cushioning, reducing impact velocity, etc.) the repetitive engagement between the valve body 442 and the valve seat 440 during cyclical opening and closing of the inlet valve assembly 426. More particularly, the central platform 526 of the valve seat 440 includes a groove 504. The damper 200 extends within the groove 504 such that the side 210 of the damper 200 is engaged in physical contact with the central platform 526 of the valve guide 520 of the valve seat 440. In the example of FIG. 6, the valve body 442 includes the valve stem 464 extending from the base 462 of the valve head 460. As shown in FIG. 6, the damper 200 extends at least partially around the valve stem 464.

In the exemplary embodiment of FIG. 6, the damper 200 is held within the groove 504 with an interference fit. But, the damper 200 can be held within the groove 504 using any other fastener and/or fit, such as, but not limited to, a retaining member substantially similar to the retaining member 208 shown in FIG. 3 (optionally including the retaining flange 212), a snap fit, adhesive, bonding, welding, bolts, screws, buckles, clips, latches, pins, nails, and/or the like.

As can be seen in FIG. 6, the damper 200 is operatively connected between the base 462 of the valve head 460 of the valve body 442 and the central platform 526 of the valve seat 440. More particularly, the operation of the damper 200 in the exemplary embodiment of FIG. 6 will now be described. In the open position of the valve head 460 of the valve body 442, the base 462 of the valve head 460 is separated from the side 206 of the damper 200. As the valve head 460 of the valve body 442 moves from the open position toward the closed position, the base 462 of the valve head 460 engages in physical contact with the side 206 of the damper 200. As the valve body 442 continues to move toward the closed position, the engagement of the sides 206 and 208 of the damper 200 with the base 462 and the central platform 526, respectively, compresses the damper 200 axially along the valve seat axis 450 until the valve head 460 of the valve body 442 reaches the fully closed position, wherein the damper 200 is fully compressed and a surface 534 of the valve head 460 of the valve body 442 is engaged in physical contact with the shoulder 458 of the valve seat 440 to thereby provide the fluid seal between the valve body 442 and the valve seat 440 (e.g., metal to metal engagement between the valve head 460 and the shoulder 458, etc.). The axial compression of the damper 200 along the valve seat axis 450 dampens (e.g., cushions, reduces impact velocity, etc.) the engagement (i.e., the impact) of the valve head 460 of the valve body 442 with the shoulder 458 of the valve seat 440. The cushioning provided by the damper 200 can reduce the wear on the valve body 442 and the valve seat 440 (e.g., the shoulder 458, etc.) over the repeated opening and closing of the inlet valve assembly 426 during operation of the reciprocating pump 100 (FIGS. 1 and 2), which can extend the life of the inlet valve assembly 426 and thereby extend the life of the fluid end portion 104 (FIGS. 1 and 2).

In some other embodiments, the central platform 526 of the valve seat 440 does not include the groove 504 and the damper 200 is fixedly secured to the central platform 526 of the valve seat 440 or is fixedly secured to the base 462 of the valve head 460 (e.g., an interference fit, a snap fit, using adhesive, bonding, welding, bolts, screws, buckles, clips, latches, pins, nails, etc.). In such an embodiment wherein the damper 200 is fixedly secured to the base 462 of the valve head 460, the side 210 of the damper is separated from the central platform 526 in the open position of the valve body 442 and engages in physical contact with the central platform 526 as the valve head 460 is moved toward the closed position of the valve body 442.

In some other embodiments, the valve body 442 does not include the valve stem 464 and the central column 522 does not include the guide opening 528 such that the central column 522 does not provide a guide feature.

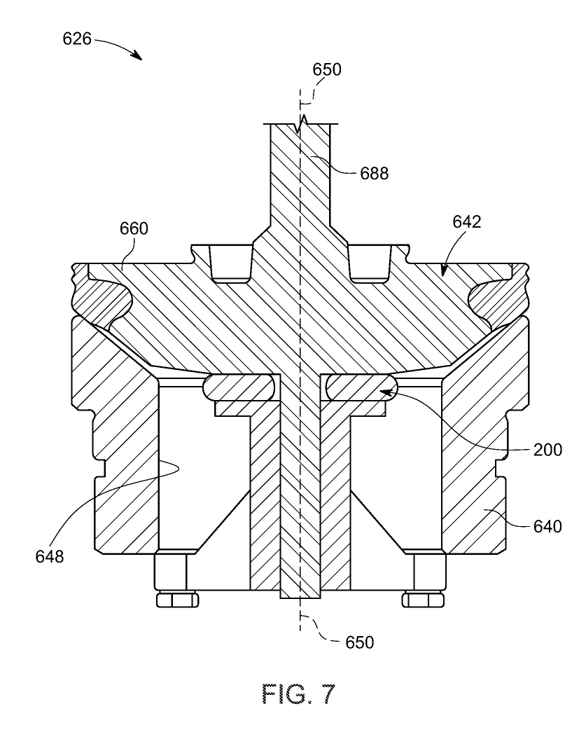

In addition or alternatively to the valve stem 464 and the valve guide 520, the inlet valve assembly 426 can include a valve stem that is received within a valve guide of the valve stop (not shown) of the inlet valve assembly 426 to guide movement of the valve body 442 along the valve seat axis 450 between the open and closed positions. For example, and referring now to FIG. 7, an inlet valve assembly 626 includes a valve seat 640 and a valve body 642 that is configured to be sealingly engaged therewith in a closed position of the valve body 642. The valve seat 640 includes an inlet valve bore 648 that extends along a valve seat axis 650.

The valve body 642 includes a valve head 660 and a valve stem 688 extending therefrom. The inlet valve assembly 626 includes a valve stop (not shown), which limits the travel of the valve body 642 in an open position of the valve body 642. The valve stem 688 is configured to be received within a valve guide (not shown) of the valve stop that is defined by an opening (not shown) that extends at least partially through the valve stop to guide movement of the valve body 642 along the valve seat axis 650 between the open and closed positions of the valve body 642, for example to prevent the valve body 642 from tilting relative to the valve seat axis 650 as the valve body 642 moves between the open and closed positions.

The inlet valve assembly 626 includes the damper 200 operatively connected between the valve body 642 and the valve seat 640 for dampening (e.g., cushioning, reducing impact velocity, etc.) the repetitive engagement between the valve body 642 and the valve seat 640 during cyclical opening and closing of the inlet valve assembly 626.

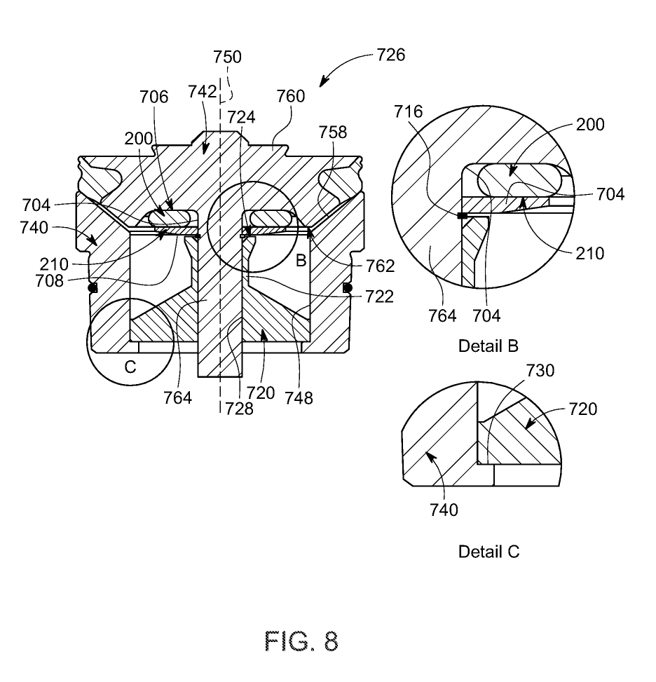

Referring now to FIG. 8, another configuration of the damper 200 within an inlet valve assembly 726 is shown. The inlet valve assembly 726 includes a valve seat 740 and a valve body 742 that is configured to be sealingly engaged therewith in a closed position of the valve body 742. The valve seat 740 includes a shoulder 758 and an inlet valve bore 748 that extends along a valve seat axis 750. The valve body 742 includes a valve head 760 having a base 762. In the example shown in FIG. 8, a valve stem 764 extends from the base 762 of the valve head 760. In the closed position of the valve body 742, the valve head 760 sealingly engages at least a portion of the shoulder 758 of the valve seat 740 to prevent fluid flow through the inlet valve assembly 726.

The damper 200 is shown in FIG. 8 as operatively connected between the valve body 742 and the valve seat 740 for dampening (e.g., cushioning, reducing impact velocity, etc.) the repetitive engagement between the valve body 742 and the valve seat 740 during cyclical opening and closing of the inlet valve assembly 726. More particularly, in the example of FIG. 8, the valve head 760 of the valve body 742 includes a groove 704 that extends into the base 762 of the valve head 760. The damper 200 extends within the groove 704 such that the side 206 of the damper 200 is engaged in physical contact with the base 762 of the valve head 760 when the valve body 742 is in the closed position. As shown in FIG. 8, the damper 200 extends at least partially around the valve stem 764.

In the exemplary embodiment of FIG. 8, the damper 200 is held within the groove 704 by a retaining member 708 that extends over the side 210 of the damper 200. In addition or alternatively, the damper 200 can be fixedly secured to the valve body 742 within the groove 704 (e.g., an interference fit, a snap fit, adhesive, bonding, welding, bolts, screws, buckles, clips, latches, pins, nails, etc.) to hold the damper 200 within the groove 704. The retaining member 708 can facilitate providing that the damper 200 deforms in a predetermined manner during compression of the damper 200, for example a substantially even deformation across the width W (FIG. 3) of the damper 200, etc. Referring now to detail B of FIG. 8, the retaining member 708 can be held in position over the side 210 of the damper 200 at least in part by a pin 716 that extends into the valve stem 764. But, additionally or alternatively any other method, structure, and/or the like can be used to secure the retaining member 708 to the valve body 742 (e.g., an interference fit, a snap fit, an adhesive, bonding, welding, screws, buckles, clips, latches, bolts, nails, etc.). The pin 716 can function as a stop that facilitates holding the retaining member 708 (and/or the damper 200) in the position during movement of the valve body 742 to the open position.

The valve seat 740 includes a valve guide 720 having a central column 722 that extends within the inlet valve bore 748 along the valve seat axis 750. The central column 722 of the valve guide 720 defines a central platform 724 of the valve seat 740. The valve guide 720 includes a guide opening 728 that receives the valve stem 764 of the valve body 742 therein. The valve guide 720 is thereby configured to guide movement of the valve body 742 along the valve seat axis 750 between the open and closed positions of the valve body 742, for example to prevent the valve body 742 from tilting relative to the valve seat axis 750 as the valve body 742 moves between the open and closed positions. In the example of FIG. 8, the valve guide 720 is a separate component from the remainder of the valve seat 740. As shown in Detail C of FIG. 8, the valve guide 720 rests on a shoulder 730 of the valve seat 740.

Referring now to FIG. 9, another configuration of a damper 900 within an inlet valve assembly 826 is shown. The inlet valve assembly 826 includes a valve seat 840 and a valve body 842 that is configured to be sealingly engaged therewith in a closed position of the valve body 842. The valve seat 840 includes a shoulder 858 and an inlet valve bore 848 that extends along a valve seat axis 850. The valve body 842 includes a valve head 860 having a base 862. In the example shown in FIG. 9, a valve stem 864 extends from the base 862 of the valve head 860. In the closed position of the valve body 842, the valve head 860 sealingly engages at least a portion of the shoulder 858 of the valve seat 840 to prevent fluid flow through the inlet valve assembly 826.

The damper 900 is shown in FIG. 9 as operatively connected between the valve body 842 and the valve seat 840 for dampening (e.g., cushioning, reducing impact velocity, etc.) the repetitive engagement between the valve body 842 and the valve seat 840 during cyclical opening and closing of the inlet valve assembly 826. In the embodiment of FIG. 9, the damper 900 is an elastic washer (e.g., a Belleville washer, etc.). In the example of FIG. 9, the valve head 860 of the valve body 842 includes a groove 804 that extends into the base 862 of the valve head 860. The damper 900 extends within the groove 804 such that the damper 900 is engaged in physical contact with the base 962 of the valve head 960 when the valve body 942 is in the closed position. As shown in FIG. 9, the damper 900 extends at least partially around the valve stem 864.

In the exemplary embodiment of FIG. 9, the damper 900 is held within the groove 804 by a retaining member 808. In addition or alternatively, the damper 900 can be fixedly secured to the valve body 842 within the groove 804 (e.g., an interference fit, a snap fit, adhesive, bonding, welding, bolts, screws, buckles, clips, latches, pins, nails, etc.) to hold the damper 900 within the groove 804. The retaining member 808 can facilitate providing that the damper 900 deforms in a predetermined manner during compression of the damper 900, for example a substantially even deformation across the width of the damper 900, etc. Referring now to detail D of FIG. 9, the retaining member 808 can be held in position over the damper 900 at least in part by a pin 816 that extends into the valve stem 864. But, additionally or alternatively any other method, structure, and/or the like can be used to secure the retaining member 808 to the valve body 842 (e.g., an interference fit, a snap fit, an adhesive, bonding, welding, screws, buckles, clips, latches, bolts, nails, etc.). The pin 816 can function as a stop that facilitates holding the retaining member 808 (and/or the damper 900) in the position during movement of the valve body 842 to the open position.

In operation, axial compression of the damper 900 along the valve seat axis 850 dampens (e.g., cushions, reduces impact velocity, etc.) the engagement (i.e., the impact) of the valve head 860 of the valve body 842 with the shoulder 858 of the valve seat 840. The cushioning provided by the damper 900 can reduce the wear on the valve body 842 and the valve seat 840 (e.g., the shoulder 858, etc.) over the repeated opening and closing of the inlet valve assembly 826 during operation of the reciprocating pump 100 (FIGS. 1 and 2), which can extend the life of the inlet valve assembly 826 and thereby extend the life of the fluid end portion 104 (FIGS. 1 and 2).

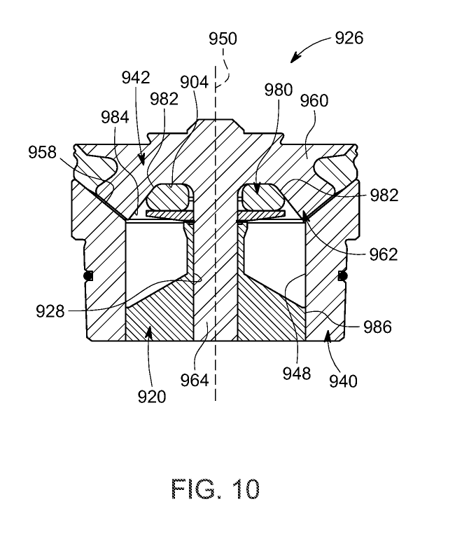

Referring now to FIG. 10, another configuration of a damper 980 within an inlet valve assembly 926 is shown. The inlet valve assembly 926 includes a valve seat 940 and a valve body 942 that is configured to be sealingly engaged therewith in a closed position of the valve body 942. The valve seat 940 includes a shoulder 958 and an inlet valve bore 948 that extends along a valve seat axis 950. The valve body 942 includes a valve head 960 having a base 962. In the example shown in FIG. 10, a valve stem 964 extends from the base 962 of the valve head 960. In the closed position of the valve body 942, the valve head 960 sealingly engages at least a portion of the shoulder 958 of the valve seat 940 to prevent fluid flow through the inlet valve assembly 926.

The damper 980 is shown in FIG. 10 as operatively connected between the valve body 942 and the valve seat 940 for dampening (e.g., cushioning, reducing impact velocity, etc.) the repetitive engagement between the valve body 942 and the valve seat 940 during cyclical opening and closing of the inlet valve assembly 926. FIG. 10 illustrates an embodiment wherein the damper 980 includes a different shape as compared to the damper 200 shown in FIGS. 2-8. More particularly, the damper 980 has an outer shoulder 982 that is tapered such that the damper 980 has a complementary shape as compared to a shoulder 984 of a groove 904 within which the damper 980 extends. As shown in FIG. 10, the damper 980 extends at least partially around the valve stem 964.

The valve seat 940 includes a valve guide 920 that includes a guide opening 928 that receives the valve stem 964 of the valve body 942 therein. The valve guide 920 is thereby configured to guide movement of the valve body 942 along the valve seat axis 950 between the open and closed positions of the valve body 942, for example to prevent the valve body 942 from tilting relative to the valve seat axis 950 as the valve body 942 moves between the open and closed positions. In the example of FIG. 10, the valve guide 920 is a separate component from the remainder of the valve seat 940.

As can be seen in FIG. 10, the inlet valve bore 948 of the valve seat 940 is tapered inwardly along the valve seat axis 950. The valve guide 920 includes a shoulder 986 that is tapered inwardly along the valve seat axis 950 such that the valve guide 920 has a complementary shape relative to the inlet valve bore 948 of the valve seat 940. The complementary taper of the inlet valve bore 948 and the valve guide 920 facilitates holding the valve guide 920 in position within the valve seat 940. In the example of FIG. 10, the inlet valve bore 948 and the shoulder 986 of the valve guide 920 are tapered at an angle of approximately 4° relative to the valve seat axis 950. But, the inlet valve bore 948 and the shoulder 986 can be tapered at any other angle relative to the valve seat axis 950.

Again, it should be understood that each of the inlet valve assemblies 126, 326, 426, 626, 726, 826, and 926 of FIGS. 3, 5, 6, 7, 8, 9, and 10, respectively, can be used in place of the inlet valve assembly 126 shown in FIG. 2. Moreover, although shown and described herein with respect to inlet valve assemblies, the damper embodiments described and/or illustrated herein (e.g., the various damper embodiments described herein and/or shown in FIGS. 2-10, etc.) are not limited thereto, but rather may be used with any valve assembly. For example, the damper embodiments described and/or illustrated herein may be used with the outlet valve assembly 128 (FIG. 2).

The following clauses describe further aspects of the disclosure:

Clause Set A:

A1. A valve assembly for a reciprocating pump, said valve assembly comprising:

a valve seat comprising a shoulder;

a valve body configured to move relative to the valve seat between an open position and a closed position, the valve body being separated from the shoulder of the valve seat in the open position, the valve body being sealingly engaged with the shoulder of the valve seat in the closed position; and

a damper operatively connected between the valve body and the valve seat.

A2. The valve assembly of clause A1, wherein the damper is engaged in physical contact with a base of the valve body.

A3. The valve assembly of clause A1, wherein the valve seat comprises a valve guide and the valve body comprises a valve stem received within the valve guide, the damper extending at least partially around the valve stem of the valve body.

A4. The valve assembly of clause A1, wherein the valve body comprises a base and the valve seat comprises a central platform, the damper being operatively connected between the base of the valve body and the central platform of the valve seat.

A5. The valve assembly of clause A1, wherein the valve seat comprises a valve guide and the valve body comprises a base and a valve stem extending from the base, the valve stem being received within the valve guide, the damper being engaged with the base of the valve body in the closed position of the valve body, the damper being engaged with the valve guide of the valve seat in the closed position of the valve body.

A6. The valve assembly of clause A1, wherein the valve body comprises a groove and the damper extends within the groove.

A7. The valve assembly of clause A1, wherein the valve seat comprises a groove and the damper extends within the groove.

A8. The valve assembly of clause A1, wherein the valve body comprises a groove and the damper extends within the groove, the damper being held within the groove by a retaining member.

A9. The valve assembly of clause A1, wherein the damper is fixedly secured to at least one of the valve body or the valve seat.

A10. The valve assembly of clause A1, further comprising a valve stop having a valve guide, the valve body comprising a valve stem received within the valve guide of the valve stop.

A11. The valve assembly of clause A1, wherein the damper comprises an elastomeric material.

A12. The valve assembly of clause A1, wherein the damper comprises at least one of a donut shape, a ring shape, or a circular shape.

Clause Set B:

B1. A reciprocating pump assembly comprising:

a fluid passage; and

a valve assembly held within the fluid passage, the valve assembly comprising a valve seat having a shoulder, the valve assembly further comprising a valve body configured to move relative to the valve seat between an open position and a closed position, the valve body being separated from the shoulder of the valve seat in the open position, the valve body being sealingly engaged with the shoulder of the valve seat in the closed position, the valve assembly further comprising a damper operatively connected between the valve body and the valve seat.

B2. The reciprocating pump assembly of clause B1, wherein the valve seat comprises a valve guide and the valve body comprises a valve stem received within the valve guide, the damper extending at least partially around the valve stem of the valve body.

B3. The reciprocating pump assembly of clause B1, wherein the valve seat comprises a valve guide and the valve body comprises a base and a valve stem extending from the base, the valve stem being received within the valve guide, the damper being engaged with the base of the valve body in the closed position of the valve body, the damper being engaged with the valve guide of the valve seat in the closed position of the valve body.

B4. The reciprocating pump assembly of clause B1, wherein at least one of the valve body or the valve seat comprises a groove, the damper extending within the groove.

B5. The reciprocating pump assembly of clause B1, wherein at least one of the valve seat or the valve body comprises a groove, the damper being held within the groove by a retaining member.

B6. The reciprocating pump assembly of clause B1, wherein the valve assembly further comprises a valve stop having a valve guide, the valve body comprising a valve stem received within the valve guide of the valve stop.

B7. The reciprocating pump assembly of clause B1, wherein the damper comprises an elastomeric material.

Clause Set C:

C1. A valve assembly for a reciprocating pump, said valve assembly comprising:

a valve seat comprising a shoulder and a valve guide;

a valve body configured to move relative to the valve seat between an open position and a closed position, the valve body being separated from the shoulder of the valve seat in the open position, the valve body being sealingly engaged with the shoulder of the valve seat in the closed position, the valve body comprising a base and a valve stem extending from the base, the valve stem being received within the valve guide of the valve seat; and

a damper operatively connected between the valve body and the valve seat, wherein the damper is engaged in physical contact with the base of the valve body.

It is to be understood that the above description is intended to be illustrative, and not restrictive. For example, the above-described embodiments (and/or aspects thereof) may be used in combination with each other. Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Further, each independent feature or component of any given assembly may constitute an additional embodiment. In addition, many modifications may be made to adapt a particular situation or material to the teachings of the disclosure without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the disclosure should, therefore, be determined with reference to the appended claims, along with the full scope of equivalents to which such claims are entitled.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “clockwise” and “counterclockwise”, “left” and right”, “front” and “rear”, “above” and “below” and the like are used as words of convenience to provide reference points and are not to be construed as limiting terms.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. For example, in this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised”, “comprises”, “having”, “has”, “includes”, and “including” where they appear. The term “exemplary” is intended to mean “an example of” The phrase “one or more of the following: A, B, and C” means “at least one of A and/or at least one of B and/or at least one of C.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Although the terms “step” and/or “block” may be used herein to connote different elements of methods employed, the terms should not be interpreted as implying any particular order among or between various steps herein disclosed unless and except when the order of individual steps is explicitly described. The order of execution or performance of the operations in examples of the disclosure illustrated and described herein is not essential, unless otherwise specified. The operations may be performed in any order, unless otherwise specified, and examples of the disclosure may include additional or fewer operations than those disclosed herein. It is therefore contemplated that executing or performing a particular operation before, contemporaneously with, or after another operation is within the scope of aspects of the disclosure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A valve assembly for a reciprocating pump, said valve assembly comprising:
a valve seat comprising a shoulder;
a valve body configured to move relative to the valve seat between an open position and a closed position, the valve body being separated from the shoulder of the valve seat in the open position, the valve body being sealingly engaged with the shoulder of the valve seat in the closed position; and
a damper operatively connected between the valve body and the valve seat.

2. The valve assembly of claim 1, wherein the damper is engaged in physical contact with a base of the valve body.

3. The valve assembly of claim 1, wherein the valve seat comprises a valve guide and the valve body comprises a valve stem received within the valve guide, the damper extending at least partially around the valve stem of the valve body.

4. The valve assembly of claim 1, wherein the valve body comprises a base and the valve seat comprises a central platform, the damper being operatively connected between the base of the valve body and the central platform of the valve seat.

5. The valve assembly of claim 1, wherein the valve seat comprises a valve guide and the valve body comprises a base and a valve stem extending from the base, the valve stem being received within the valve guide, the damper being engaged with the base of the valve body in the closed position of the valve body, the damper being engaged with the valve guide of the valve seat in the closed position of the valve body.

6. The valve assembly of claim 1, wherein the valve body comprises a groove and the damper extends within the groove.

7. The valve assembly of claim 1, wherein the valve seat comprises a groove and the damper extends within the groove.

8. The valve assembly of claim 1, wherein the valve body comprises a groove and the damper extends within the groove, the damper being held within the groove by a retaining member.

9. The valve assembly of claim 1, wherein the damper is fixedly secured to at least one of the valve body or the valve seat.

10. The valve assembly of claim 1, further comprising a valve stop having a valve guide, the valve body comprising a valve stem received within the valve guide of the valve stop.

11. The valve assembly of claim 1, wherein the damper comprises an elastomeric material.

12. The valve assembly of claim 1, wherein the damper comprises at least one of a donut shape, a ring shape, or a circular shape.

13. A reciprocating pump assembly comprising:
a fluid passage; and
a valve assembly held within the fluid passage, the valve assembly comprising a valve seat having a shoulder, the valve assembly further comprising a valve body configured to move relative to the valve seat between an open position and a closed position, the valve body being separated from the shoulder of the valve seat in the open position, the valve body being sealingly engaged with the shoulder of the valve seat in the closed position, the valve assembly further comprising a damper operatively connected between the valve body and the valve seat.

14. The reciprocating pump assembly of claim 13, wherein the valve seat comprises a valve guide and the valve body comprises a valve stem received within the valve guide, the damper extending at least partially around the valve stem of the valve body.

15. The reciprocating pump assembly of claim 13, wherein the valve seat comprises a valve guide and the valve body comprises a base and a valve stem extending from the base, the valve stem being received within the valve guide, the damper being engaged with the base of the valve body in the closed position of the valve body, the damper being engaged with the valve guide of the valve seat in the closed position of the valve body.

16. The reciprocating pump assembly of claim 13, wherein at least one of the valve body or the valve seat comprises a groove, the damper extending within the groove.

17. The reciprocating pump assembly of claim 13, wherein at least one of the valve seat or the valve body comprises a groove, the damper being held within the groove by a retaining member.

18. The reciprocating pump assembly of claim 13, wherein the valve assembly further comprises a valve stop having a valve guide, the valve body comprising a valve stem received within the valve guide of the valve stop.

19. The reciprocating pump assembly of claim 13, wherein the damper comprises an elastomeric material.

20. A valve assembly for a reciprocating pump, said valve assembly comprising:
a valve seat comprising a shoulder and a valve guide;
a valve body configured to move relative to the valve seat between an open position and a closed position, the valve body being separated from the shoulder of the valve seat in the open position, the valve body being sealingly engaged with the shoulder of the valve seat in the closed position, the valve body comprising a base and a valve stem extending from the base, the valve stem being received within the valve guide of the valve seat; and
a damper operatively connected between the valve body and the valve seat, wherein the damper is engaged in physical contact with the base of the valve body.
